(19) United States
(12) Patent Application Publication
(10) Pub. No.: US 2013/0089578 A1
(43) Pub. Date: Apr. 11, 2013

(54) LIQUID INSECTICIDE INCLUDING DIATOMACEOUS EARTH

(71) Applicant: WINFIELD SOLUTIONS, LLC, Shoreview, MN (US)

(72) Inventors: Solito A. Sumulong, Eagan, MN (US); Gregory M. Finlay, Apple Valley, MN (US); Joe V. Gednalske, River Falls, WI (US); Jon Martin Gehring, Hudson, WI (US); Martyn Neil Rufus Hafley, Fort Worth, TX (US)

(73) Assignee: WINFIELD SOLUTIONS, LLC, Shoreview, MN (US)

(21) Appl. No.: 13/648,701

(22) Filed: Oct. 10, 2012

Related U.S. Application Data
(60) Provisional application No. 61/545,816, filed on Oct. 11, 2011.

(51) Int. Cl. A01N 59/16; A01P 7/04; A01N 25/04

(52) U.S. Cl. 424/400; 424/646

(57) ABSTRACT

An insecticide including diatomaceous earth in a liquid mixture of water and one or more additives is provided. The diatomaceous earth may be present in an amount between at least 20 and less than 25 weight percent of the insecticide. The insecticide is applied in liquid form to surfaces for controlling the spread of insects. The liquid component of the insecticide evaporates leaving a thin layer of the dried diatomaceous earth. Insects traversing the diatomaceous earth layer are scratched and scraped by the layer, which results in water loss from the exoskeleton and eventually death.

### FIELD OF THE INVENTION

Implementations provide insecticides including diatomaceous earth in a liquid mixture including water and optionally one or more additives.

### BACKGROUND

Controlling the spread of insects commonly involves the use of insecticides, which are generally applied to areas in which insects are discovered, areas insects are likely to infest or that are conducive to growth, or in areas in which it is desirable to prevent insect infestations. Insecticides have a wide applicability, and are commonly used in industrial, residential, business and agricultural settings.

Diatomaceous earth used as an insecticide generally involves its application in dry, powdered form. However, during its application, the dry powder-form diatomaceous earth particles may become airborne and inhaled. This may be hazardous to humans and animals with endoskeletons (e.g., pets and livestock animals). In addition, the diatomaceous earth dust may cause eye irritation and contact with the eyes or clothing should be prevented. Thus, the dry powder-form of diatomaceous earth is generally recommended to be applied in areas with adequate ventilation and those exposed to the dry powder-form of diatomaceous earth generally may be required to wear protective clothing and dust masks (e.g., NIOSH/MSHA-approved masks).

### SUMMARY

The implementations provided herein are directed to insecticides and use of the insecticides, which include diatomaceous earth in a liquid mixture that may be applied to surfaces to control the spread of insects. The insecticide may form a thin layer of diatomaceous earth, which may serve as a desiccant to insects contacting the applied diatomaceous earth. The diatomaceous earth may scrape and scratch the exoskeletons of the insects, causing the desiccating water loss, eventually leading to death.

In one implementation, an insecticide includes diatomaceous earth particles mixed in a liquid comprising water and one or more of a wetting agent, a dispersing agent, a non-foaming agent and a thickener. The diatomaceous earth particles may be present in an amount between at least 20 and less than 25 weight percent of the insecticide.

In another implementation, an insecticide includes diatomaceous earth particles mixed with water and a natural or synthetic liquid-based insecticide.

In another implementation, a method for applying an insecticide includes providing the insecticide as a mixture of diatomaceous earth particles and liquid comprising water and one or more of a wetting agent, a dispersing agent, a non-foaming agent and a thickener, and applying the insecticide in liquid form to a surface. The insecticide forms a layer of diatomaceous earth on the surface and thus serves as a desiccant to insects with exoskeletons. The diatomaceous earth particles may be present in an amount between at least 20 and less than 25 weight percent of the insecticide.

### DETAILED DESCRIPTION

The implementations provided herein are directed to insecticides in liquid form that include diatomaceous earth in a liquid containing water and at least one additive, such as a wetting agent, a dispersing agent, a non-foaming agent and a thickener. The insecticide additive may alternatively or additionally include a natural or synthetic liquid-based insecticide, e.g., insecticides with a mode of insect death generally resulting from non-mechanical means. The diatomaceous earth may be provided as a powder and may be mixed with liquid to form the insecticide. In some implementations, additives in the insecticide may alter the characteristics of the mixture. For example, the additives may make the insecticide sticky, which may be useful when applying the insecticide directly on insects. The insecticide may be applied utilizing sprayers (such as aerosols, pressurized and/or power sprayers), which may enable the insecticide to be sprayed in liquid-form in crevices, cracks, and generally in hard-to-reach areas in which a powdered insecticide may be difficult or impossible to apply.

The concentration of diatomaceous earth per unit of surface area may be controlled using spray applications, which may provide advantages over the application of dusty, solid insecticides that may be difficult to apply and may vary in concentration due to the solid insecticide being applied unevenly to surfaces. Furthermore, the liquid insecticide formulation may reduce inhalation hazards involved in mixing the dust or dry form into a slurry. Application of the liquid insecticide may improve surface adhesion making removal more difficult, for example, which may prolong outdoor insect barriers in the case of light rainfall. Upon application of the liquid insecticide, the liquid component evaporates leaving a layer of diatomaceous earth, which scrapes and tears insect exoskeletons causing the insects lose moisture and eventually die due to water loss. The liquid insecticide may solve problems associated with potentially harmful dust and airborne particles resulting from spraying powder-form insecticides by providing the diatomaceous earth and additives in liquid, thereby providing an insecticide that may be safely applied, e.g., in the presence of humans or animals or without the need for protective equipment.

The insecticide may be composed of diatomaceous earth in powder form mixed within a liquid. Powdered diatomaceous earth may generally be composed of fossilized diatoms, which may be formed of silica (e.g. amorphous silica or silicon dioxide (SiO₂)) in an amount between about 80 and 95 percent, alumina in an amount of between about 2.0 and 4.0 percent, and iron oxide in an amount of between about 0.5 and 2.0 percent. The powder may include particle sizes of between 0.25 μm to 200 μm. The powdered diatomaceous earth particles have a porous surface area for absorbing liquids. For example, the particles may include individual diatoms with a pore volume having an absorptive capacity of about 10 m²g to about 70 m²g, from about 10 m²g to 30 m²g, from about 10 m²g to 50 m²g, from about 30 to 70, and from about 50 m²g to 70 m²g.

The size of the particles may be relatively uniform or may vary. In some implementations, the diatomaceous earth may be feed grade or food grade, for example, depending on the application of the insecticide.

The diatomaceous earth utilized in the insecticide may be treated to form particles, or when provided in powder form, may be treated to alter the particles. Physical treatments may involve one or more of cutting or grinding to reduce particle size. Pressing or physically combining the particles may be used to increase the particle size. Sifting may separate the particles to provide a relatively uniform particle size. Other treatments may be applied to the diatomaceous earth such as chemical treatments, which may breakdown or modify the composition of the diatomaceous earth. In addition or alternatively, the chemical treatment may coat materials over the diatomaceous earth or may cause the diatomaceous earth to react with the applied chemicals. In one example, the diatomaceous earth may be supplemented with one or more additives and may subsequently be mixed with the liquid to form the insecticide.

In some implementations, the diatomaceous earth particles may have a relatively uniform size, e.g., about 1.0 μm or from about 0.5 to about 1.5 μm. In other implementations, the particles may be provided in a range of sizes, e.g., 0.25 μm to 10.0 μm. In some implementations, the particle size or size range may be selected to provide a biologically active substance with storage stability, operations capabilities (e.g., sprayability) or both. For example, it is believed that particles having a size of from about 0.5 to about 1.5 μm or up to about 1.0 μm may provide biological activity along with one or both of the aforementioned functions. One preferred source of the diatomaceous earth for use in the insecticide mixture is DiaSource Insect Dust made of amorphous silica (e.g., natural diatomite).

Water in the insecticide may be provided as de-aerated water, purified water, deionized water, distilled water, filtered water, or combinations thereof. Deionized water may be preferable, but tap water with some hardness (e.g., 342 ppm water hardness) may be used in the mixture. Water as a main liquid component in the insecticide may avoid or minimize volatile organic compounds (VOCs) within the insecticide. However, some implementations using water or amounts of VOCs may use glycols, other alcohols, and glycerin as thickeners.

The insecticide may include one or more additives to aid ease in handling, such as to modify the surface of the diatomaceous earth particles. This may facilitate spraying or depositing the insecticide mixture, and in addition or alternatively, may facilitate forming an insecticide film once sprayed or deposited. Such additives may include a wetting agent, a dispersant, an antifoaming agent and/or a thickener and may provide the insecticide with wetting, dispersing, non-foaming, and/or thickening properties, respectively.

Including a wetting agent in the insecticide may lower the surface tension of the insecticide to facilitate the spreading properties, penetrating properties or both. For example, the wetting agent may facilitate spraying of the insecticide across the surface to which the insecticide is applied, such as hard surfaces, carpets, fabrics, grains, plant leaves, and so on. Upon application of the liquid mixture, the wetting agent may also facilitate penetrating and spreading of the insecticide to form a film over the applied surface. In some implementations, wetting agents may include one or more of water soluble, non-ionic surfactants and aqueous anionic surfactants. For example, the wetting agent may include one or more of dioctyl sodium sulfosuccinates; lactylic esters of fatty acids; lecithins; lactylated fatty acid esters of glycerols and propylene glycols; propylene glycols; sodium alkylnaphthalene sulfonates; sodium lauryl sulfates; sodium lignosulfonates; and preferably 2-undecoxyethanol.

A dispersant may be utilized as an additive in the insecticide to prevent the particles of diatomaceous earth from clustering together, from settling within the liquid or both. For example, the dispersant may facilitate suspending the particles in isolation from one another within the liquid and may facilitate the diatomaceous earth particles remaining in a suspension for a period of time. The dispersant may additionally facilitate the application of the diatomaceous earth particles evenly across the surface to which the insecticide is applied. For example, the dispersant may facilitate lubricating properties of the insecticide to facilitate both passage of the insecticide through a sprayer system and spraying, and upon application, may facilitate distributing the diatomaceous earth particles on the applied surface. Examples of dispersants may include aqueous non-ionic surfactants and anionic surfactants, as in the wetting agent examples above. In some implementations, the dispersants may include one or more of sodium lignosulfonates; 2-pyrrolidinone, 1-ethenyl-, homopolymer; and preferably modified styrene acrylic polymer.

In some implementations, the insecticide may include an antifoaming agent as an additive for reducing or preventing the formation of foam within the mixture. The antifoaming agent may also facilitate movement of entrapped air out of the mixture. The antifoaming agent may enable the wetting agent and the dispersant, when included, to function properly within the mixture, and may facilitate spraying of the insecticide while reducing the chances of the sprayer becoming clogged with foam or entrained air. Examples of antifoaming agents may include one or more of the following: decanoic acid; lauric acid; mineral oil; myristic acid; octanoic acid; oleic acid; oxystearin; palmitic acid; petrolatum (wax, jelly); propylene glycol; silicon dioxide; sorbitan monostearate; stearic acid; silicone and/or polydimethylsiloxane; and emulsions thereof.

A thickener used as an additive in the insecticide may increase viscosity, change consistency, stabilize and/or facilitate suspending of the diatomaceous earth particles within the liquid mixture. The thickener may also enable the liquid mixture of diatomaceous earth to be applied to areas of a surface and may form a wet, gel-like deposit prior to drying. This may enable the diatomaceous earth particles to stick to the insect by way of the thickening agent while the applied mixture is wet. Examples of thickeners may include acacia; acetylated distarch adipate; acetylated distarch phosphate; agar; alginic acid; calcium alginate; cellulose; distarch phosphate; starch (treated with acids and/or enzymes, modified); and preferably gums (e.g. arabic, ghatti, guar).

Other additives may be included in the insecticide and may be premixed or tank mixed products. Some non-limiting examples of additives may include: anti-freeze to prevent the mixture from freezing (e.g., polypropylene glycols); antimicrobials additives (e.g., calcium sorbates, chlorines, cupric sulfates, diethyl pyrocarbonates, potassium nitrates, potassium nitrites, potassium sorbates, sodium nitrates, sodium nitrites) that may act as a preservative to prevent the growth of bacteria and other microorganisms in the insecticide mixture; botanicals (e.g., pyrethrum/pyrethrins, D-limonene, linalool, ryania, rotenone, eugenol (clove oil), other essential oils (e.g., lemongrass, pepper wintergreen, rosemary, cinnamon, sesame, thyme, cedar oils and capsaicin), neem oil (Azadirachtin), nicotine, castro oil, and any FIFRA 25(b) of FIFRA) and Naturalytes (e.g., spinosid) may serve as a natural insecticide in the insecticide mixture; microbial products (e.g., Bacillus thuringeinis and Beauveria bassiana) may serve as a biological insecticide; oxadiazines (e.g., Indoxacarb) may serve as a pyrazoline-type insecticide; anthranilic diamide (e.g., chlorantraniliprole) may serve as an insecticide to activate insect ryanodine receptors for the release of calcium ions; juvenile hormone mimics (e.g., fenoxycarb; pyriproxifen; methoprene; and hydroprene), pyrroles (e.g., chlorfenapyr), phenylpyrazoles (e.g., fipronil), organophosphates (e.g., malathion and chlorpyrifos), inorganics (e.g., sulfur and dormant and horticultural oils) and insect growth regulators such as chitin synthesis inhibitors (e.g., hexaflumuron; noviflumuron; diflubenzuron; buprofezine; cyromazine; and halofenozide) may serve as insecticides; acaricides such as miticides (e.g., avermectin) and ixodicides may be used to control mites and ticks. In some implementations, the insecticide may be mixed with other active ingredients and adjuvants.

Because diatomaceous earth may causes insect death at a slower rate compared to natural or synthetic liquid-based insecticides, the insecticide having the diatomaceous earth may be mixed with a pesticide having fast-acting properties, e.g., properties affecting the nervous system. The natural or synthetic liquid-based insecticides may be provided in an effective amount that causes insect death. For example, pyrethroids (including bifenthrin, cypermethrin, cyfluthrin, beta-cyfluthrin, deltamethrin, lambdacyhalothrin, permethrin, fenvalerate, esfenvalerate, zeta-cypermethrin) for paralyzing the nervous system of insects may be included as an additive to the insecticide. Botanical actives such as pyrethrins for affecting the nervous system, e.g., causing uncontrolled, excessive nerve firings, may be included as an additive. Chloronicotinyls (including immidicloprid, acetamiprid, thiomethoxin, dinotefuran) may additionally or alternatively be added to the insecticide for causing the exposed insect to have uncontrolled, excessive nerve firings. Indoxacarb as an additive may block nerve sodium channels and may serve as an insecticide additive.

In another implementation, an insect attractant (e.g., Z-9 tricosene or pheromone attractants) in an effective amount may be included as an additive, for example, to attract houseflies to insecticide-treated surfaces.

While natural or synthetic liquid-based pesticides may act on the insects at a faster rate compared to the diatomaceous earth, these pesticides tend to degrade upon exposure to sunlight, whereas diatomaceous earth does not. In addition, because the diatomaceous earth does not degrade upon application to surfaces or exposure to sunlight, the insecticide mixture with diatomaceous earth serves as an insecticide as long as diatomaceous earth is present, and consequently does not have a shelf life.

In some implementations, one additive may provide properties for two or more of the above-identified additive properties. For example, cellulose may provide dispersing and thickening properties, and may thus serve both as a dispersant and as a thickener. In another example, lecithin or other oils may provide dispersing and wetting properties, and may thus serve both as a dispersant and as a wetting agent. Aqueous non-ionic surfactants and anionic surfactants may serve as both dispersants and wetting agents.

The composition of the disclosed insecticides may be provided within the ranges provided in Table 1.

TABLE 1

| | |
|---|---|
| Diatomaceous Earth | 1-40% |
| Water | 46-77.69% |
| Additive | |
| Dispersant | 1.0-10.0% |
| Wetting Agent | 0.1-1.0% |
| Antifoaming Agent | 0.1-1.0% |
| Thickener | 0.1-1.0% |
| Antifreeze | 1.0-10.0% |
| Antimicrobial Agent | 0.01-1.0% |

In some implementations, the insecticide may be formed of a dilution of between 1 and 40 percent by weight diatomaceous earth (e.g., 25 percent by weight) and the balance water. In other implementations, the insecticide may be formed of a dilution of about 25 percent by weight diatomaceous earth, about 5.5 percent by weight of a dispersant (e.g., Metasperse 550L from Croda), about 0.5 percent by weight of a wetting agent (e.g., Easy Wet P-20 from International Specialty Products), about 0.1 percent by weight of an antifoaming agent (e.g., Drexel 30% antifoam), about 0.15 percent by weight of a thickener (e.g., xanthan gum), about 6 percent by weight of an antifreeze (e.g., propylene glycol), about 0.05 percent by weight of an antimicrobial agent (e.g., Proxel GXL from Arch or Nuosept 498 from International Specialty Products) and the balance water. In preferred implementations, the diatomaceous earth is present in the insecticide from between at least 20 percent less than 25 percent by weight, between at least 21 percent up to 24 percent by weight, between at least 22 percent up to 24 percent by weight, between at least 22 percent up to 23 percent by weight; or at about 21 percent, 22 percent, 23 percent or 24 percent by weight. It has been discovered that insecticides with diatomaceous earth particulates as an active ingredient cause insect death and can be sprayed through a nozzle at concentrations within and between at least about 20 percent and less than 25 percent by weight.

In further implementations, the insecticide may be formed of a dilution of diatomaceous earth and a natural or synthetic liquid-based insecticides as the active ingredients. In some example implementations, the diatomaceous earth may be present in the insecticide in the amounts stated above along with an effective amount of natural or synthetic liquid-based insecticide. It has been discovered that by including the combination of diatomaceous earth and the natural or synthetic liquid-based insecticide as active ingredients, application of the insecticide may result in both rapid and gradual insect death.

In one implementation, the insecticide mixture may be formed by adding the components to a reactor. The ingredients may be added to grinding media in a reactor. In some implementations, the diatomaceous earth may be physically treated, chemically treated, or treated with one or more of the additives prior to the introduction of water. Alternatively, the additive(s) may be introduced to the water, and thereafter, the diatomaceous earth may be added to the liquid. In other implementations, one or more additives may be mixed with the diatomaceous earth prior to the introduction of water, and thereafter one or more additives may be added to the liquid mixture.

The components within the insecticide may behave or have characteristics of a mixture, a suspension, a colloid or combinations thereof. The characteristics of the mixture may depend on the size and amount of the diatomaceous earth particles and/or the additive(s) utilized in the insecticide. For example, the insecticide may be provided as a mixture, and the granular diatomaceous earth particles may settle to the bottom of the liquid. Preparing the mixture for application of the insecticide to surfaces may involve agitating the mixture by shaking or stirring to suspend the diatomaceous earth particles in the liquid.

In another example, the insecticide may be provided as a suspension in which all or a portion of the diatomaceous earth particles are suspended within the liquid. The diatomaceous earth particles may remain in suspension for a period of time, such as 15 minutes. The particle size may be about 5.0 μm, about 10 μm, greater than 5 μm or greater than 10 μm. Compared to the mixture, preparing the insecticide suspension for surface treatment may involve relatively less or no agitating or mixing prior to application.

In some implementations, the insecticide may be provided as a colloid in which the diatomaceous earth particles remain dispersed throughout the insecticide. The colloid may utilize diatomaceous earth particles having a size of 10 μm or less (e.g., about or less than 5 μm, 1.0 μm or 0.5 μm), for example. The colloid may be applied to a surface by spraying or deposition with little or no preparation required.

In some implementations, the insecticide may be prepared within a manufacturing facility and may be transported as a liquid product to the end user. The end user may be an insect control professional or other user desiring to control the spread of insects. Thus, the end user may receive the insecticide in a form that is substantially ready to use. Alternatively, components of the insecticide may be mixed by the end user. Alternatively, the diatomaceous earth may be provided in a liquid (e.g., water and one or more additives) and other additives may be added by the user prior to application.

In use, the liquid insecticide may be applied by pouring, manually applying (e.g., wiping) or by spraying (such as spray aerosols, or by using pressurized and/or power sprayers). The insecticide may be applied to areas where insects have been seen or are expected to be seen (e.g., pest harborages, conducive areas and any area where pests congregate). Utilizing a sprayer or a spray aerosol, the insecticide may exit a spray nozzle in a stream, in droplets, in a mist, or combinations thereof. Spray treatment may involve spraying the insecticide at a pressure of up to 25 pounds per square inch (psi). The spray-applied insecticide may be provided as one or more of a surface, spot, broadcast, crack and crevice spray treatment. A sufficient amount of water or liquid in the insecticide may ensure complete coverage in such treatments.

Applying the diatomaceous earth in the liquid component of the insecticide may enable the insecticide to be applied to a given surface area with increased accuracy and control and the layer of diatomaceous earth may be relatively uniform. Upon evaporation of the liquid component, the insecticide may form a thin, relatively uniform layer of diatomaceous earth effective as an insecticide. The dried layer of diatomaceous earth may be in addition to other dried natural or synthetic liquid-based insecticide or pesticide components, which may serve insecticide functions such as an insect attractant, a repellant, or one that affects insect biological systems (e.g., the nervous system, the production of energy, the production of cuticle, the endocrine system, and water/sodium balance).

In some implementations, the dried insecticide components may serve other functions such as adding flavoring or aroma to surfaces to which the insecticide is applied, which may be useful in feed settings for livestock. For example, the insecticide may be formed of a mixture of food grade or feed grade components including food or feed grade diatomaceous earth and flavorings or aromas. This may enable organisms to consume (intentionally or unintentionally) insecticide without harmful effects.

In some implementations, the insecticide may be applied to the back of cattle or other livestock in order to reduce the population of flies in the livestock setting.

In some implementations of use, the insecticide may be applied in liquid form in agricultural settings to growing crops, to seeds and to grains (e.g., in stored grain settings). For example, the insecticide may be sprayed (e.g., in aerosol form) directly on leaves of growing crops and may include an insect attractant. In another example, the insecticide may be sprayed in an area where grain and seeds are stored. As the grain and seeds are poured into a storage area, the insecticide may be sprayed in a transfer area through which the grains and seeds move (e.g., via a conveyor or by falling through a chute). The insecticide may coat all or a portion of the grains and seeds in a thin layer. Insects traversing the insecticide-coated leaves, seeds and/or grains thereafter rapidly lose water (desiccate) and die due to the water loss by the diatomaceous earth causing abrasions and cuts in the insect exoskeletons.

In other implementations of use, the insecticide may be applied in liquid form to spaces, surfaces, and crevices of residential and commercial areas including but not limited to: lawns; ornamental plants; shrubs; trees; parks; apartments; recreational areas; athletic fields; grain bins; homes; hospitals; nursing homes; hotels; day care facilities; schools; office buildings; parking lots; businesses; restaurants; shopping centers; malls; food processing plants; dairies; kennels; meat/poultry plants; hog farms; other livestock premises; interior plant-scapes; warehouses; food and feed storage facilities; grain bins; greenhouses and golf courses.

The insecticides provided herein may be useful in preventing the spread of insects that pose health hazards including but not limited to: bees; bed bugs; fire ants; German roaches; fleas; flies (house, stable, horn); scorpions; ticks; mosquitoes; wasps; as well as other insects with hard exoskeletons that are vulnerable to damage by diatomaceous earth, which may found in indoor and outdoor settings where humans and animals reside.

The insecticides provided herein may be useful in pest control for crawling pests, which may include but is not limited to: ants; beetles; borers; boxelder bugs; cadelle beetles; carpenter ants; carpenter bees; chinch bugs; peridomestic cockroaches (American; smokey brown & Oriental); clover mites; crickets; darkling beetles (wireworms); earwigs; granary weevils; pill bugs; sowbugs; spiders (brown recluse & black widow are health hazards); angoumois grain moths; booklice; carpet beetles; cigarette beetles; cluster flies; confused flour beetles; drug store beetles; fruit flies; gnats; grain mites; Indian meal moths; meal worms; Mediterranean flour moths; millipedes; mud daubers; red flour beetles; rice weevils; saw-toothed grain beetles; silverfish and spider mites.

As described above, once the insecticide is applied, the liquid component may evaporate and the dried insecticide may form a layer of diatomaceous earth on the applied surface, which may serve as a desiccant to insects with exoskeletons. In some implementations, the sticky nature of the product when dried and the lack of solar degradation provide a valuable insecticide product for exterior perimeter applications, for use as a resistance management tool as well as product useful in food processing facilities. However, in some implementations, once the insecticide is applied in liquid form, it may be effective as an insecticide prior to evaporation of the liquid component. For example, where the liquid component includes a gel-like consistency, the insecticide in liquid form may be immediately effective due to the gel-like liquid carrying the diatomaceous earth adhering to exoskeletons of the insects. As the insects move, the adhered diatomaceous earth would eventually scratch and tear exoskeletons causing water loss and death.

By diluting the diatomaceous earth in the insecticide, the accuracy of the sprayed insecticide may be increased, which may be useful in and near residential settings. In addition, the insecticide including diatomaceous earth may provide benefits due to the non-toxic nature of non-airborne diatomaceous earth to organisms such as humans, pets and livestock animals. That is, organisms with endoskeletons (e.g., an internal bone structure) may come into contact with diatomaceous earth, and may even consume diatomaceous earth (e.g., food or feed grade diatomaceous earth), without harmful effects. However, inhalation of airborne diatomaceous earth may be irritating to lung tissue and may cause silicosis if the content of crystalline silica is too high. For example, the OSHA standard for crystalline silica is <0.1 percent, and above this amount is considered hazardous, with a potential for causing silicosis in the lungs and also now considered a potential carcinogen to other vital organs. However, the crystalline silica content of the diatomaceous earth provided in the preferred embodiments herein is at undetectable at levels, e.g., less than 0.1 percent. Furthermore, because the insecticide is applied in liquid form, the diatomaceous earth applied to surfaces is wet, and spraying the insecticide generally does not result in the diatomaceous earth remaining airborne upon exiting a spray nozzle. This reduces the risk that the user spraying the insecticide, and the humans and animals proximate the sprayed and applied insecticide, will inhale the diatomaceous earth particles. Once the diatomaceous earth has been applied and the liquid component of the insecticide has evaporated, the diatomaceous earth forms a thin layer that may adhere to surfaces, e.g., due to the sticky nature of the insecticide and/or due to implantation of the silica on or in the applied surface, thereby reducing the risk of the user inhaling the dried insecticide. In some implementations, the insecticide may include an additive such as high fructose corn syrup or other stickers that causes the dried diatomaceous earth to adhere to surfaces to reduce the chance of the diatomaceous earth becoming airborne, which may be useful when applying the insecticide to slippery surfaces. However, diatomaceous earth is surprisingly persistent on surfaces and may be formulated without additives with adhering properties.

The liquid insecticide may also solve problems associated with the harmful effects of some synthetic chemicals by providing the liquid insecticide with naturally occurring components including diatomaceous earth as well as natural additives or additives derived from natural substances. Thus, the liquid insecticide may also be composed entirely of food grade or feed grade components including the diatomaceous earth and additives and thus may be safely applied to feed for subsequent ingestion by livestock animals without requiring washing.

Although the present disclosure provides references to preferred embodiments, persons skilled in the art will recognize that changes may be made in form and detail without departing from the spirit and scope of the invention.

What is claimed is:

1. An insecticide comprising diatomaceous earth particles mixed in a liquid comprising water and one or more of a wetting agent, a dispersing agent, a non-foaming agent and a thickener, wherein the diatomaceous earth particles are present in an amount between at least 20 and less than 25 weight percent of the insecticide.

2. The insecticide of claim 1, wherein the liquid comprises the water and each of the wetting agent, the dispersing agent, the non-foaming agent and the thickener.

3. The insecticide of claim 1, further comprising one or more of an antifreeze and an antimicrobial agent.

4. The insecticide of claim 1, wherein the insecticide comprises a suspension of the diatomaceous earth in the liquid.

5. The insecticide of claim 4, wherein the diatomaceous earth particles comprise a size of about 10 μm.

6. The insecticide of claim 1, the insecticide comprises a colloid of diatomaceous earth dispersed in the liquid.

7. The insecticide of claim 6, wherein the diatomaceous earth particles comprise a size of about 1.0 μm.

8. The insecticide of claim 1, further comprising a pyrethroid.

9. The insecticide of claim 1, further comprising a botanical active.

10. The insecticide of claim 1, further comprising a chloronicotinyl.

11. The insecticide of claim 1, further comprising indoxacarb.

12. An insecticide comprising diatomaceous earth particles mixed in a liquid comprising water and a natural or synthetic liquid-based insecticide.

13. The insecticide of claim 12, wherein the diatomaceous earth particles are present in an amount between about 1 and about 40 percent by weight of the insecticide.

14. The insecticide of claim 13, wherein the natural or synthetic liquid-based insecticide comprises one or more of a pyrethroid, a botanical active, a chloronicotinyl and indoxacarb.

15. The insecticide of claim 14, wherein the natural or synthetic liquid-based insecticide is present in an effective amount.

16. A method for providing an insecticide, comprising:
providing the insecticide comprising a mixture of diatomaceous earth particles and liquid comprising water and one or more of a wetting agent, a dispersing agent, a non-foaming agent and a thickener, wherein the diatomaceous earth particles comprise between at least 20 and less than 25 weight percent of the insecticide; and
applying the insecticide in liquid form to a surface;
wherein the insecticide forms a layer of diatomaceous earth on the surface and serves as a desiccant to insects with exoskeletons.

17. The method of claim 16, further comprising providing the insecticide with each of the wetting agent, the dispersing agent, the non-foaming agent and the thickener.

18. The method of claim 16, wherein applying the insecticide comprises spraying the insecticide.

19. The method of claim 18, wherein spraying the insecticide at a pressure up to 25 psi.

20. The method of claim 16, wherein the insecticide in the liquid form comprises a gel-like consistency upon application; and wherein the gel-like liquid adheres to insects.
